(19) United States
(12) Patent Application Publication
(10) Pub. No.: US 2004/0129448 A1
(43) Pub. Date: Jul. 8, 2004

(54) Electrical cable and method of making

(76) Inventor: Michael Andrew De Rooij, Clifton Park, NY (US)

Correspondence Address: GENERAL ELECTRIC COMPANY, GLOBAL RESEARCH, PATENT DOCKET RM. BLDG. K1-4A59, SCHENECTADY, NY, 12301-0008, US

(21) Appl. No.: 10/336,882

(22) Filed: Jan. 7, 2003

(51) Int. Cl. H01B 5/00

(52) U.S. Cl. 174/126.2

(57) ABSTRACT

An electrical cable and method of making, the method comprising: providing a litz cable having a plurality of electrical conductors; electrically coupling at a first end of the litz cable a subset of the electrical conductors to produce a first coupled subset leaving an uncoupled remainder of the electrical conductors; and electrically coupling at a second end of the litz cable the uncoupled remainder of the electrical conductors to produce a second coupled subset.

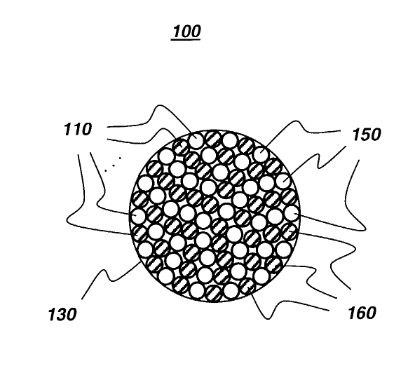

### BACKGROUND

The present invention relates generally to the field of electrical cables and more specifically to the field of manufacturing litz cables.

In a wide variety of applications, litz wire (also called “litzendraht wire”) is used as a method to reduce the high frequency resistance of electrical cables. A typical litz wire consists of a number of individually insulated conductors woven together so that each conductor assumes all possible positions in the cross section of the assembly. This arrangement of the conductors tends to reduce high frequency proximity effect, thereby resulting in lower high frequency impedance.

In some applications, for example, a resonant converter, litz wire is wound to form a magnetic component, i.e., an inductor or a transformer, and one or more capacitors are used to form a resonant circuit. An opportunity exists, therefore, to reduce the component count in such resonant circuits by manufacturing a litz wire with an intrinsic capacitance or embedded capacitance.

### SUMMARY

The opportunity described above is addressed, in one embodiment of the present invention, by a method of making an electrical cable, the method comprising: providing a litz cable having a plurality of electrical conductors; electrically coupling at a first end of the litz cable a subset of the electrical conductors to produce a first coupled subset leaving an uncoupled remainder of the electrical conductors; and electrically coupling at a second end of the litz cable the uncoupled remainder of the electrical conductors to produce a second coupled subset.

### DRAWINGS

These and other features, aspects, and advantages of the present invention will become better understood when the following detailed description is read with reference to the accompanying drawings in which like characters represent like parts throughout the drawings, wherein:

The FIGURE illustrates a cross-section diagram of an electrical cable in accordance with one embodiment of the present invention.

### DETAILED DESCRIPTION

In accordance with one embodiment of the present invention, the FIGURE illustrates a diagram of an electrical cable 100 comprising a litz cable 130, a first coupled subset 150, and a second coupled subset 160. As shown, Litz cable 130 has a plurality of electrical conductors 110. At a first end of litz cable 130, a subset of electrical conductors 110 is electrically coupled to form first coupled subset 150, leaving an uncoupled remainder of electrical conductors 110. The uncoupled remainder is electrically coupled to form second coupled subset 160 at a second end of litz cable 130. The capacitance between first coupled subset 150 and second coupled subset 160 is the desired cable capacitance. In some embodiments, the first end and second end are at the same end of cable assembly 130 providing a parallel capacitance. In other embodiments, the first end and second end are at opposite ends of cable assembly 130 providing a series capacitance.

In another embodiment in accordance with the embodiment of the FIGURE, members of first coupled subset 150 have different respective lengths. Members of second coupled subset 160 have lengths in one-to-one correspondence with the different respective lengths of the members of first coupled subset 150. By varying the lengths of electrical conductors 110 in this embodiment, the capacitance and the current density along the lengths of first coupled subset 150 and second coupled subset 160 may be optimized for the required capacitance and better utilization of the conductor cross sectional area.

In another embodiment in accordance with the embodiment of the FIGURE, a first insulating gap is produced at a first gap location along the length of first coupled subset 150. In some embodiments, a second insulating gap is produced at a second gap location along the length of second coupled subset 160. The first and second insulating gaps also serve to alter overall cable capacitance by introducing additional series capacitance.

While only certain features of the invention have been illustrated and described herein, many modifications and changes will occur to those skilled in the art. It is, therefore, to be understood that the appended claims are intended to cover all such modifications and changes as fall within the true spirit of the invention.

1. A method of making an electrical cable, said method comprising:
providing a litz cable having a plurality of electrical conductors;
electrically coupling at a first end of said litz cable a subset of said electrical conductors to produce a first coupled subset leaving an uncoupled remainder of said electrical conductors; and
electrically coupling at a second end of said litz cable said uncoupled remainder of said electrical conductors to produce a second coupled subset.

2. The method of claim 1 wherein said first end and said second end are at opposite ends of said litz cable.

3. The method of claim 1 wherein:
members of said first coupled subset have different respective lengths; and
members of said second coupled subset have lengths in one-to-one correspondence with said different respective lengths of said members of said first coupled subset.

4. The method of claim 1 further comprising producing a first insulating gap at a first gap location along the length of said first coupled subset.

5. The method of claim 1 further comprising producing a second insulating gap at a second gap location along the length of said second coupled subset.

6. A method of making an electrical cable, said method comprising:
providing a litz cable having a plurality of electrical conductors;
electrically coupling at a first end of said litz cable a subset of said electrical conductors to produce a first coupled subset leaving an uncoupled remainder of said electrical conductors;
electrically coupling at a second end of said litz cable said uncoupled remainder of said electrical conductors to produce a second coupled subset, said first end and said second end being at opposite ends of said litz cable; and
producing a first insulating gap at a first gap location along the length of said first coupled subset.

7. The method of claim 6 wherein:
members of said first coupled subset have different respective lengths; and
members of said second coupled subset have lengths in one-to-one correspondence with said different respective lengths of said members of said first coupled subset.

8. The method of claim 6 further comprising producing a second insulating gap at a second gap location along the length of said second coupled subset.

9. An electrical cable comprising:
a litz cable having a plurality of electrical conductors;
a first coupled subset of said electrical conductors, said first coupled subset being electrically coupled at a first end of said litz cable; and
a second coupled subset of said electrical conductors, said second coupled subset being electrically coupled at a second end of said litz cable.

10. The electrical cable of claim 9 wherein said first end and said second end are at opposite ends of said litz cable.

11. The electrical cable of claim 9 wherein:
members of said first coupled subset have different respective lengths; and
members of said second coupled subset have lengths in one-to-one correspondence with said different respective lengths of said members of said first coupled subset.

12. The electrical cable of claim 9 wherein said first coupled subset has a first insulating gap at a first gap location along the length of said first coupled subset.

13. The electrical cable of claim 9 wherein said second coupled subset has a second insulating gap at a second gap location along the length of said second coupled subset.

14. An electrical cable comprising:
a litz cable having a plurality of electrical conductors;
a first coupled subset of said electrical conductors, said first coupled subset being electrically coupled at a first end of said litz cable; and
a second coupled subset of said electrical conductors, said second coupled subset being electrically coupled at a second end of said litz cable,
said first end and said second end being at opposite ends of said litz cable,
said first coupled subset having a first insulating gap at a first gap location along the length of said first coupled subset.

15. The electrical cable of claim 14 wherein:
members of said first coupled subset have different respective lengths; and
members of said second coupled subset have lengths in one-to-one correspondence with said different respective lengths of said members of said first coupled subset.

16. The electrical cable of claim 14 wherein said second coupled subset has a second insulating gap at a second gap location along the length of said second coupled subset.
